(19) United States
(12) Patent Application Publication
(10) Pub. No.: US 2005/0215125 A1
(43) Pub. Date: Sep. 29, 2005

(54) Memory card connector with erroneous card insertion prevention

(76) Inventors: Yasuyoshi Matsumoto, Kanagawa (JP); Mitsuhiro Tomita, Kanagawa (JP)

Correspondence Address: Stacey E Caldwell;Molex Incorporated, 2222 Wellington Court, Lisle, IL, 60532, US

(21) Appl. No.: 10/512,533

(22) PCT Filed: Apr. 30, 2003
(86) PCT No.: PCT/US03/13661

§ 371 Date: May 25, 2005

(30) Foreign Application Priority Data
Apr. 30, 2002 (JP) 127733/2002

(51) Int. Cl. H01R 13/64

(52) U.S. Cl. 439/680

(57) ABSTRACT

A memory card connector includes a housing defining a front receptacle area communicating with a cavity for receiving a memory card. A plurality of terminals are mounted on the housing in a side-by-side array transversely across a rear of the housing. The terminals have contact portions at a rear of the cavity for engaging contacts on a side of the memory card. A blocking post is disposed immediately in front of the contact portion of at least one of the terminals to prevent an erroneously inserted memory card from engaging the contact portion.

### FIELD OF THE INVENTION

This invention generally relates to the art of electrical connectors and, particularly, to a memory card connector. The invention is specifically directed to a system for protecting the terminals of the card connector in the event of erroneous or abnormal insertion of the memory card into the connector.

### BACKGROUND OF THE INVENTION

Memory cards are known in the art and contain intelligence in the form of a memory circuit or other electronic program. Some form of card reader reads the information or memory stored on the cad. Such cards are used in many applications in today=s electronic society, including video cameras, smartphones, music players, ATMs, cable television decoders, toys, games, PC adapters and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card. Ejecting devices often are provided for facilitating inserting and ejecting the memory card to and from the card connector.

Card connectors of this type are disclosed in detail in Japanese Unexamined Patent Publication No. 2001-160458 which corresponds generally to FIGS. 13 and 14 herein, as well as in Japanese Unexamined Patent Publication No. 2001-167232 which corresponds generally to FIGS. 15 and 16 herein. In FIGS. 13 and 14, reference numeral 100 represents a card receptacle cavity, 110 represents terminals, 110a represents contact portions of the terminals and 120 represents a memory card inserted into the cavity in an erroneous orientation. In FIGS. 15 and 16, reference numeral 200 represents a card receiving cavity, 210 represents terminals, 210a represents contact portions of the terminals and 220 represents a memory card inserted into the cavity in an erroneous orientation.

In such card connectors, it is possible to insert the memory card into the card-receiving cavity in an erroneous orientation, such as a reversed front-to-back orientation or an upside-down orientation. Such erroneous insertions could cause damage or deformation to the contact portions of the terminals if not corrected. In order to understand these possibilities, it can be seen in FIGS. 13-16 that the memory card has grooves or recesses 300 in the underside thereof at the normal or proper front or insertion edge 302 of the card. The contact portions of the connector terminals move into these grooves or recesses when the card is properly oriented and properly inserted into the cavity of the card connector. On the other hand, if the card is inserted in a reversed front-to-rear orientation as shown in FIGS. 13-16, the normally rear or trailing edge 304 of the card, which is a solid edge, is inserted and could damage the contact portions of the terminal. Similar potential damage could occur if the card is inserted in an upside-down orientation. Therefore, systems are provided to prevent this damage due to the erroneous insertion of the memory card.

For instance, in the card connector shown generally in FIGS. 13 and 14, housing ribs 130 are provided at opposite sides of at least one of the terminals and against which the erroneously inserted card abut as shown in the drawings to prevent the card from being fully inserted into a damaging position against the contact portions of the terminals. In the card connector of FIGS. 15 and 16, the terminal itself has side wing portions 230 which function like housing ribs 130 at opposite sides of the terminal for abutment with the solid edge 304 of the memory card to prevent the memory card from being fully inserted into damaging engagement with the contact portions of the terminals.

Details of these types of damage prevention systems can be derived from the aforementioned publications.

Problems are encountered by providing extra housing ribs 130 (FIGS. 13 and 14) and extra terminal wings 230 (FIGS. 15 and 16) disposed in clearances between the various terminals. As stated, the terminals move into grooves 30 in the memory card, and either the grooves must be narrowed or the entire connector be made wider to accommodate these housing ribs or terminal wings because of their disposition between the terminals. In addition, the height of the ribs or terminal wings are relatively low and it is possible for an erroneously inserted card simply to ride over the ribs or wings. The ribs and particularly the terminal wings typically are not robust structures and are prone to breakage. The present invention is directed to providing an improved system which solves these various problems.

### SUMMARY OF THE INVENTION

An object, therefore, of the invention is to provide a new and improved memory card connector with an improved terminal protection system which prevents erroneous memory card insertion.

In the exemplary embodiment of the invention, a memory card connector includes a housing defining a front receptacle area communicating with a cavity for receiving a memory card. A plurality of terminals are mounted on the housing in a side-by-side array transversely across a rear of the housing. The terminals have contact portions at a rear of the cavity for engaging contacts on a side of the memory card. A blocking post is disposed immediately in front of the contact portion of at least one of the terminals to prevent an erroneously inserted memory card from engaging the contact portion.

As disclosed herein, the blocking post is formed integrally with a bottom wall of the housing. Preferably, a plurality of the blocking posts project upwardly in front of the contact portions of a plurality of the terminals.

According to one aspect of the invention, a blocking flange extends transversely across the housing generally parallel to the array of terminals and in front of the contact portions of a plurality of the terminals. A plurality of the blocking posts project upwardly from the blocking flange in front of the contact portions. Preferably, the blocking posts are integral with the blocking flange and the blocking flange, in turn, is integral with a bottom wall of the housing.

Another feature of the invention is the provision of a plurality of ribs projecting rearwardly from the blocking flange between the plurality of terminals. Preferably, the ribs are integral with the blocking flange.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a top plan view of a memory card connector according to the invention, with the metal shell of the connector removed to show the interior of the connector;

FIG. 2 is an enlarged plan view of the area encircled at “A” of FIG. 1;

FIG. 3 is a front elevational view of the connector, again with the metal shell removed;

FIG. 4 is an enlarged elevational view of the area indicated at “B” in FIG. 3;

FIG. 5 is an enlarged vertical section taken generally along line 5-5 in FIG. 1, and showing a memory card in the process of being inserted into the connector;

FIG. 6 is a view similar to that of FIG. 5, but with the memory card fully inserted into the connector;

FIG. 7 is a view similar to that of FIGS. 5 and 6, but showing the memory card inserted in an erroneous orientation;

FIG. 8 is an enlarged vertical section taken generally along 8-8 of FIG. 1, with the memory card in the process of being inserted into the connector;

FIG. 9 is a view similar to that of FIG. 8, with the memory card fully inserted into the connector;

FIG. 10 is a view similar to that of FIGS. 8 and 9, but with the memory card inserted in an erroneous orientation;

FIG. 11 is a view similar to that of FIG. 2, but of a second embodiment of the invention;

FIG. 12 is a view similar to that of FIG. 4, but of a third embodiment of the invention; and

FIGS. 13-16 are views of the prior art as described in the “Background”, above.

### DETAILED DESCRIPTION OF THE PREFERRED EMBODIMENTS

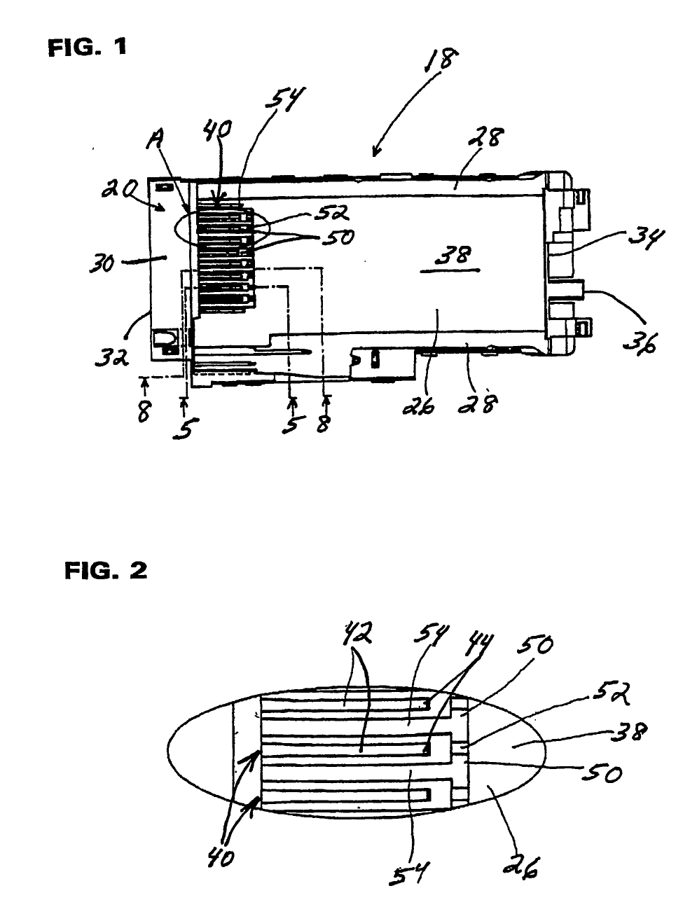

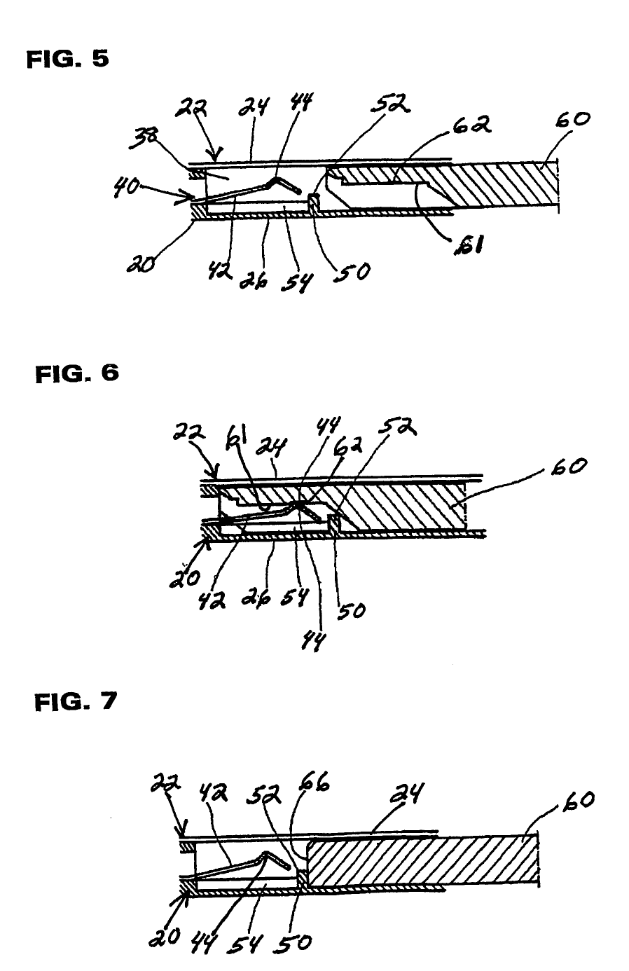

Referring to the drawings in greater detail, and first to FIG. 1, the invention is embodied in a memory card connector, generally designated 18, which includes a dielectric housing, generally designated 20, which may be molded of insulating material such as plastic or the like. A metal shell, generally designated 22 (FIG. 5 and subsequent views) covers the housing and includes a top plate 24. The metal shell has been removed from the depiction of FIG. 1 in order to be able to see the interior components of the connector.

Still referring to FIG. 1, housing 20 of memory card connector 18 includes a bottom wall 26 and a pair of side walls 28. A terminal mounting portion 30 of the housing is disposed at a rear end 32 of the connector. The housing defines a front receptacle area 34 at a front end 36 of the connector, with the front receptacle area 34 communicating with an interior cavity 38 of the connector for receiving a memory card as described hereinafter. Actually, interior cavity 36 is defined by bottom wall 26 and side walls 28 of the housing as well as top plate 24 of metal shell 22. In essence, front receptacle area 34 forms an opening through which the memory card is inserted into cavity 38.

A plurality of terminals, generally designated 40, are mounted in rear mounting portion 30 of housing 20. The terminals are in a side-by-side array transversely of the connector (i.e., transverse to the insertion direction of the memory card). Each terminal includes a flexible contact arm 42 as best seen in FIG. 2. Each flexible contact arm includes an upwardly disposed contact portion or tip 44 at the distal end of the arm, as best seen in FIG. 5. The contact arms and contact portions are located at the rear, inside area of interior card-receiving cavity 38.

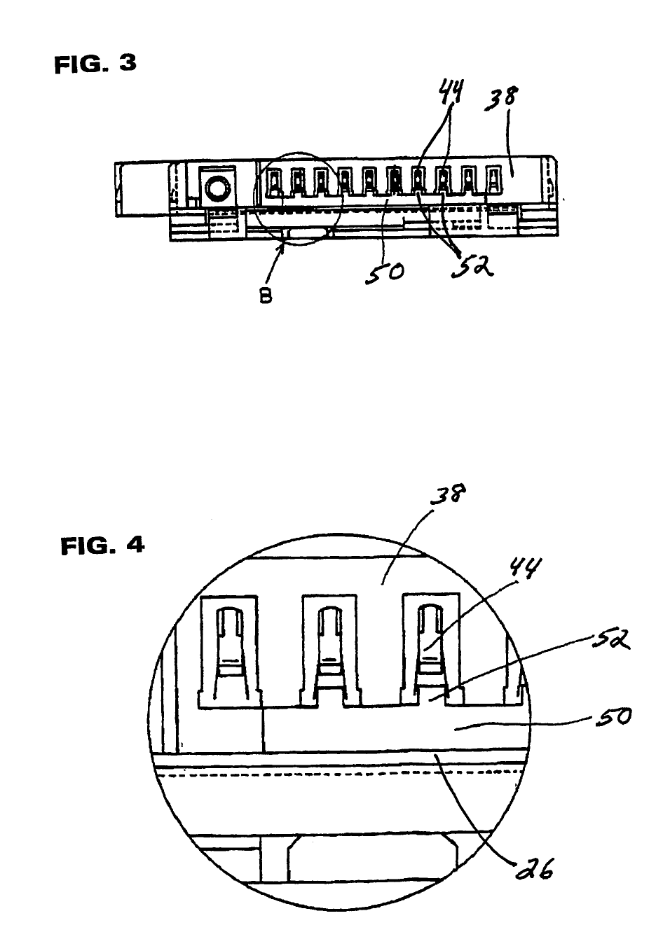

Referring to FIGS. 2-4 in conjunction with FIG. 1, the invention contemplates the provision of a blockage system for preventing an erroneously inserted memory card from ever reaching contact portions 44 of contact arms 42 of terminals 40. More particularly, a blocking flange 50 extends transversely across cavity 38 and housing 20 generally parallel to the side-by-side array of terminals and in front of contact arms 42 of the terminals. The blocking flange projects upwardly from bottom wall 26 of the housing. Preferably, the blocking flange is integral with the housing, such as integrally molding the flange with the bottom wall of the housing. At least one, but preferably a plurality of blocking posts 52 project upwardly from the top of blocking flange 50 in alignment with and immediately in front of contact portions 44 at the distal ends of contact arms 42 of terminals 40. FIGS. 2-4 clearly show how blocking posts 52 are in alignment with the contact portions of the terminals. FIG. 2 clearly shows how the blocking posts are located in front of or on the insertion side of the contact portions. The posts preferably are molded integrally with blocking flange 50. Finally, a plurality of ribs 54 are formed integrally with and project rearwardly from flange 50 between the plurality of contact arms 42.

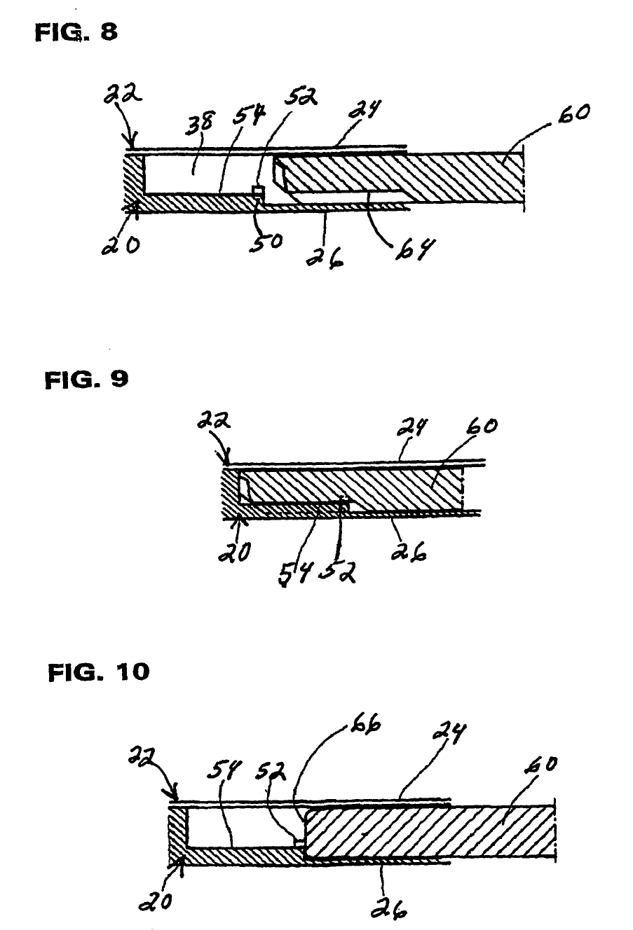

FIGS. 5, 6, 8 and 9 show a memory card 60 in the process (FIGS. 5 and 8) of being inserted into cavity 38 until the memory card reaches its fully inserted position of FIGS. 6 and 9. In other words, the memory card is shown being inserted in its normal or correct orientation. When so oriented, grooves or recesses 61 in the underside of the front edge of the memory card are aligned with blocking posts 52 and contact portions 44 of the terminals as seen in FIGS. 5 and 6, whereby contacts 62 on the underside of the card within recesses 61 can engage contact portions 44 when the card is fully inserted as seen in FIG. 6. In other words, blocking posts 52 ride into the grooves or recesses 61 and do not interfere with or block insertion of the memory card when the card is properly or correctly oriented. FIGS. 8 and 9 show that memory card 60 has a shallow groove or recess 64 along substantially the entire width of the front edge of the card for accommodating blocking flange 50 and ribs 54.

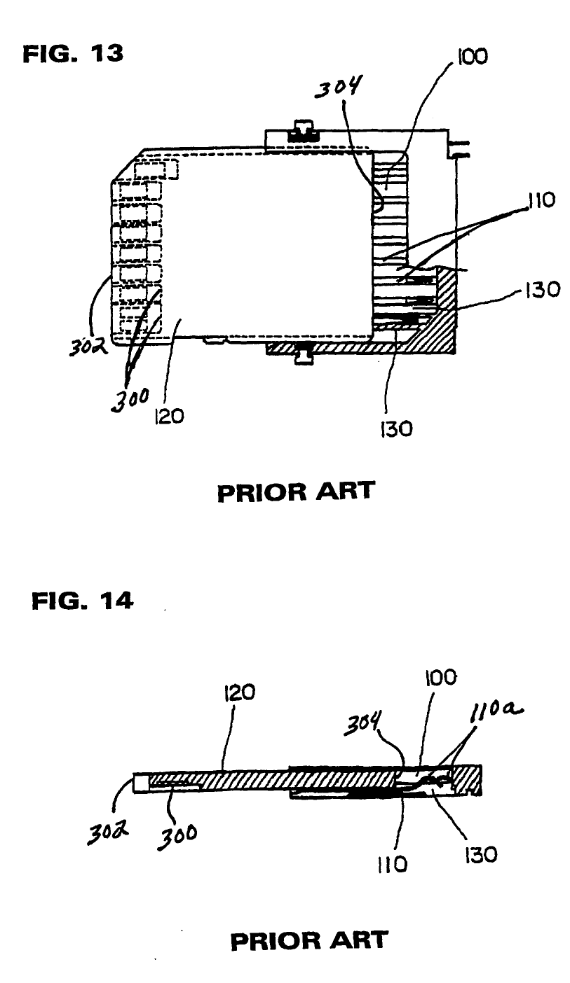

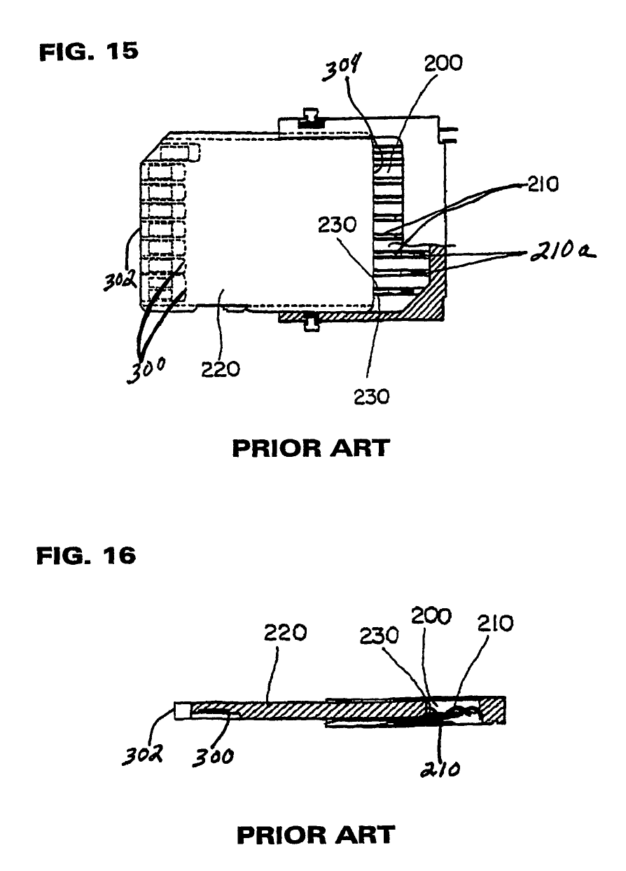

On the other hand, FIGS. 7-10 show memory card 60 erroneously inserted into the connector with a trailing or rear end or edge 66 of the card inserted first into cavity 38. As described in relation to FIGS. 13-16 in the “Background”, above, this rear and normally trailing edge of the memory card is solid and does not have any recesses or grooves therein. Therefore, the solid edge of the erroneously inserted memory card will abut against blocking flange 50 and blocking posts 52 before the card reaches contact portions 44 of the terminals. The contact portions, thereby, are protected against damage or breakage. The same blocking action will occur if the memory card is erroneously inserted in an upside-down orientation because the front top corner or edge of the memory card in its normal orientation is solid and will abut against blocking flange 50 and blocking posts 52.

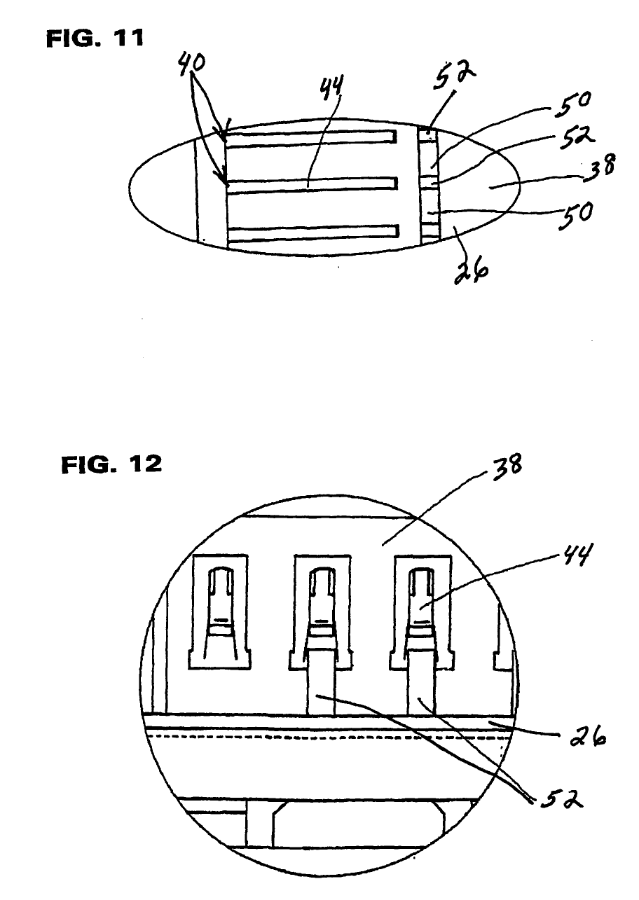

FIG. 11 shows a second embodiment of the invention wherein transversely extending blocking flange 50 and upstanding blocking posts 52 are used and function as described above. In this embodiment, ribs 54 (FIG. 2) have been eliminated and it can be seen that they are not present in FIG. 11.

FIG. 12 shows a third embodiment of the invention and corresponds to the depiction of FIG. 4. It can be seen that transversely extending blocking flange 50 (FIG. 4) has been eliminated. Still, a plurality of upstanding blocking posts 52 project upwardly from bottom wall 26 of the connector housing for blocking an erroneously inserted memory card. It can be seen that the blocking posts 52 in the third embodiment of FIG. 12, again, are in alignment with and in front of contact portions 44 of the terminals to protect the contact portions in the event of an erroneously inserted memory card.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector, comprising:
a housing defining a front receptacle area communicating with a cavity for receiving a memory card;
a plurality of terminals mounted on the housing in a side-by-side array transversely across a rear of the housing, the terminals having contact portions at a rear of the cavity for engaging contacts on a side of the memory card; and
a blocking post immediately in front of the contact portion of at least one of the terminals to prevent an erroneously inserted memory card from engaging the contact portion.

2. The memory card connector of claim 1 wherein said blocking post is formed integrally with a bottom wall of the housing.

3. The memory card connector of claim 1, including a blocking flange extending transversely across the housing generally parallel to said array of terminals and in front of the contact portions of a plurality of said terminals.

4. The memory card connector of claim 3, including a plurality of said blocking posts projecting upwardly from said blocking flange in front of said plurality of said terminals.

5. The memory card connector of claim 4, including a plurality of ribs projecting rearwardly from said blocking flange between said plurality of said terminals.

6. A memory card connector, comprising:
a housing of dielectric plastic material and including a bottom wall and a front receptacle area communicating with a cavity for receiving a memory card;
a plurality of terminals mounted on the housing in a side-by-side array transversely across a rear of the housing, the terminals having contact portions at a rear of the cavity for engaging contacts on a side of the memory card;
a blocking flange extending transversely across the housing generally parallel to said array of terminals and in front of the contact portions of a plurality of said terminals, the blocking flange being molded integrally with the bottom wall of the housing; and
at least one blocking post integral with the blocking flange immediately in front of the contact portion of at least one of the terminals to prevent an erroneously inserted memory card from engaging the contact portion.

7. The memory card connector of claim 6, including a plurality of said blocking posts integral with and projecting upwardly from said blocking flange in front of a plurality of said terminals.

8. The memory card connector of claim 7, including a plurality of ribs projecting rearwardly from said blocking flange between said plurality of said terminals.

9. The memory card connector of claim 8 wherein said ribs are integral with said blocking flange.
